(19) United States
(12) Patent Application Publication
(10) Pub. No.: US 2026/0219126 A1
(43) Pub. Date: Jul. 30, 2026

(54) LEAK DETECTION METHOD WITH TIME DELAY FOR DETECTING A LEAK THAT AFFECTS A TIRE CURING MEMBRANE OR THE INFLATION CIRCUIT THEREOF

(71) Applicant: COMPAGNIE GENERALE DES ETABLISSEMENTS MICHELIN, Clermont-Ferrand (FR)

(72) Inventors: Benoit CHAMBONNIERE, Clermont-Ferrand (FR); Yann BINDA, Clermont-Ferrand (FR); Sébastien BAUBIAT, Clermont-Ferrand (FR); Julien MOREY, Clermont-Ferrand (FR)

(73) Assignee: COMPAGNIE GENERALE DES ETABLISSEMENTS MICHELIN, Clermont-Ferrand (FR)

(21) Appl. No.: 19/141,399

(22) PCT Filed: Dec. 13, 2023
(86) PCT No.: PCT/EP2023/085552

§ 371 Date: Jun. 20, 2025

(30) Foreign Application Priority Data
Dec. 22, 2022 (FR) 2214214

(51) Int. Cl. G01M 3/32; B29D 30/06

(52) U.S. Cl. CPC G01M 3/3272; B29D 30/0654; B29D 30/0662; B29D 2030/0659

(57) ABSTRACT

The leak detection method allows tires to be cured in a mold. The method includes, after opening the mold, a testing step (S200), which comprises a partial reinflation sub-step (S201), during which the curing membrane is reinflated. When the internal pressure prevailing in the curing membrane reaches a predetermined test pressure, the curing membrane is isolated and a predetermined time delay period is allowed to elapse. At the end of the time delay, the reference pressure of the internal pressure is measured, then an observation sub-step (S203), during which the evolution of the internal pressure is observed relative to the reference pressure in order to identify a leakage situation.

### CROSS-REFERENCE TO RELATED APPLICATION

This application claims priority to and the benefit of PCT Patent App. No. PCT/EP2023/085552, filed on Dec. 13, 2023, and entitled “LEAK DETECTION METHOD WITH TIME DELAY FOR DETECTING A LEAK THAT AFFECTS A TYRE CURING MEMBRANE OR THE INFLATION CIRCUIT THEREOF” and to French Patent App. No. FR2214214, filed on Dec. 22, 2022, and entitled “LEAK DETECTION METHOD WITH TIME DELAY FOR DETECTING A LEAK THAT AFFECTS A TYRE CURING MEMBRANE OR THE INFLATION CIRCUIT THEREOF,” the entire contents of which are both herein incorporated by reference.

### BACKGROUND

### 1. Field

The present disclosure relates to the field of manufacturing tires intended to be fitted to the wheels of vehicles, notably pneumatic tires.

More specifically, it relates to the field of the operation for curing tires, which allows its definitive appearance to be conferred on a tire, notably by shaping the tread patterns of the tire, and vulcanising the tire.

### 2. Related Art

It is known, in order to carry out this curing operation, to place an unvulcanised, or at the very least not entirely vulcanised, blank tire, or “green tire”, in a curing mold, the inner wall of which corresponds to the negative impression of the tire to be obtained, then to close the curing mold, and then to force a resilient curing membrane, located inside the mold, to expand between the beads of the tire, by means of a pressurised inflation fluid, such as water vapour, in such a way that the outer surface of the curing membrane comes into abutment against the inner surface of the tire and presses the tire against the inner wall of the mold. The heat supplied by the mold and by the inflation fluid allows the tire to vulcanise. After the curing operation, the membrane is deflated, the mold is opened, and the cured tire is extracted in order to be replaced with a new green tire for a new curing operation.

The thermal and mechanical conditions of the repeated use of the curing membrane are particularly severe, and are therefore the source of damage to the curing membrane, notably by means of the appearance of perforations that cause the curing membrane to lose its seal, and which can, in some cases, cause the curing membrane to tear during a curing operation.

Of course, such a failure of the curing membrane generally results in the tire being scrapped, either because the tire will have been insufficiently cured due to the interruption of the curing operation, or even because the tire will have been improperly shaped because it was impossible to pressurise the membrane, or because the tire will have been damaged and thus weakened by ingress of the inflation fluid that will have leaked out of the curing membrane and which will have crept into the very structure of the tire, thereby causing decohesion between constituent layers of rubber of the tire.

Since the damage to the curing membrane is a progressive process, even though it is highly variable from one membrane to another, it has been contemplated for any leaks affecting the curing membrane to be detected in order to allow preventive, but nevertheless non-premature replacement of the curing membrane, before a tear occurs in the curing membrane.

Thus, a method is known, notably from document EP 1213573, for leak detection of a curing membrane, whereby, after the curing operation, the curing mold is opened while the curing membrane is still pressurised, so that, if the curing membrane is perforated, some of the pressurised water vapour contained in the curing membrane can escape through the perforation and force a passage between the outer surface of the curing membrane and the inner surface of the tire, until it reaches a humidity sensor that is placed in the vicinity of the central axis of the mold.

However, such a known method allows only highly imperfect and fairly unreliable leak detection, since, in order for the detection to be effective, on the one hand, the orifice that is the source of the leak must be large enough to allow a sufficient amount of vapour to escape so that the resulting variation in humidity in the vicinity of the humidity sensor is perceptible by the humidity sensor and, on the other hand, the cured tire, which is still in the mold, does not close the leakage orifice too firmly so that the vapour can force the passage between the membrane and the tire, and finally the passage that the vapour creates between the curing membrane and the tire effectively leads the flow of vapour to the humidity sensor, without dispersing the flow within the mold or diverting the flow of vapour to another exhaust orifice that would be remote from the humidity sensor.

Furthermore, such a method is potentially dangerous, since it involves opening the mold while the curing membrane is still highly pressurised, because a high pressure is actually required to generate the leakage flow and to force the water vapour to pass between the curing membrane and the tire. During this critical phase, the risk of tearing, or even bursting, experienced by the curing membrane, of damage to the tire and, if applicable, of spraying burning vapour and of thus causing bodily harm to an operator in the vicinity of the mold is thus increased.

In addition, the same document indicates that a leak detection system that would no longer be based on a humidity measurement but rather on a pressure measurement would not be reliable, and in particular unable to detect small perforations, as the leakage rate, and therefore the corresponding pressure variation, would then be so low that it would be undetectable in practice.

The inventors have also been able to confirm this problem of the undetectability of small leaks for themselves using known methods, by observing that, during sealing tests performed by them according to these known methods, phenomena involving the condensation of the water vapour used to inflate the membrane occur, and that these condensation phenomena cause pressure drops inside the membrane, with the amplitude of these drops being of the same order of magnitude as, or even greater than, the amplitude of the pressure variations attributable to the leak itself. It is then impossible to distinguish between a leak and a normal condensation phenomenon, the effects of which mask those of the leak.

Furthermore, a curing membrane may experience a leak that is enough to cause damage to the tire, notably by allowing enough inflation fluid to escape to cause decohesion of the constituent layers of the tire, but which is nevertheless too small to be directly detected on the curing facility. In such a situation, the failure of the curing facility may only appear much later, either directly on the curing facility itself, when the leak ultimately causes a clearly visible tear of the curing membrane, or indirectly, downstream of the curing facility, when it is found, on a quality control facility for the finished tires, that the tires from the curing facility have defects. However, a detrimental consequence of the delayed nature of detecting the defect of the membrane is that the curing facility is likely to produce, during the period of time that separates the appearance of the leak from the detection of the defect, a whole batch of defective tires, before the leak in the curing membrane is finally diagnosed and the defective membrane is replaced. Of course, this results in a waste of raw materials and energy, and therefore an industrial loss of efficiency.

### SUMMARY

The aims assigned to the present disclosure therefore relate to overcoming the aforementioned disadvantages and proposing a new method for detecting leaks within a tire curing facility, and more specifically for detecting leaks affecting a curing membrane, in a particularly reliable and early manner, even when these leaks result from small perforations in the curing membrane, and to do so quickly, in order to have the lowest possible impact on the useful time of the curing facility.

The aims assigned to the present disclosure are achieved by means of a leak detection method for detecting a leak within a curing facility for curing tires, the facility comprising:
a mold, which is arranged to alternately assume a closed configuration, in which the inner wall of the mold, which corresponds to the negative impression of the tire, delimits a molding cavity and allows an operation for curing the tire, and an open configuration, which allows a cured tire to be extracted from the mold after the curing operation and to be replaced with a green tire;
a curing membrane, the inner surface of which delimits an inflation chamber for inflating the curing membrane, and the outer surface of which is arranged, during the curing operation and under the action of a pressure, called “curing pressure”, that is applied in the inflation chamber, to come into abutment against the inner surface of the tire in order to press the tire against the inner wall of the mold;
an inflation circuit, which comprises at least one intake valve for introducing a pressurised inflation fluid into the curing membrane, in the inflation chamber, in order to inflate the curing membrane;
a pressure measurement device arranged to measure the pressure, called “internal pressure”, that prevails inside the curing membrane, in the inflation chamber, the method comprising:
a step (S100) of opening the mold, during which step, after having deflated the curing membrane, the mold is placed in the open configuration;
a testing step (S200), which comprises:
   a partial reinflation sub-step (S201), during which, while the mold is in the open configuration, the opening of the intake valve is controlled in order to introduce inflation fluid into the inflation chamber so as to increase the internal pressure that prevails in the inflation chamber and thus cause the curing membrane to reinflate, while measuring the internal pressure prevailing in the inflation chamber by means of the pressure measurement device;
   then a stabilisation sub-step (S202), which is triggered when the internal pressure prevailing in the inflation chamber reaches a predetermined threshold, called “test pressure”, which is selected so as to be lower than the curing pressure, and according to which, on the one hand, the inflation chamber is isolated by controlling the closure of the intake valve, and, on the other hand, a time delay with a predetermined duration, called “time delay period” is applied, and, at the end of the time delay period, the value, called “reference pressure”, of the internal pressure that prevails in the inflation chamber is measured;
      then an observation sub-step (S203), which involves observing how the internal pressure prevailing in the inflation chamber evolves over a predetermined duration, called “observation period” (d_203), in order to identify an evolution of the internal pressure, relative to the reference pressure, which represents a leakage situation.

Advantageously, the implementation of a time delay according to the present disclosure, triggered when the selected test pressure is reached and the closure of the intake valve is ordered, allows the system to be provided with a certain amount of stabilisation, and thus allows the transient phenomena to be eliminated that cause pressure variations that are likely to disrupt the detection of a leak. These transient phenomena notably can be linked:
to the inertia of the intake valve, which inertia is likely to cause the actual internal pressure value to overshoot relative to the selected test pressure, and to do so as long as the increase in the internal pressure during the reinflation phase generally exhibits particularly fast dynamics; and/or
to possible pressure oscillations linked to the mechanical reactions of the intake valve, to the compressibility of the inflation fluid and/or to the elastic or visco-elastic behaviour of the curing membrane.

Thus, a pressure variation is able to be very precisely detected that is indicative of a leak, following the attenuation or even the extinction of possible transient disruptive phenomena. The possible residual amplitude of the possible transient disruptive phenomena is consequently low enough, or even zero, when the reference pressure is measured at the end of the time delay/stabilisation phase, then during the actual observation phase, such that the possible residual amplitude of the transient disruptive phenomena, on the one hand, does not falsify the value of the reference pressure, and, on the other hand, does not mask the detection of a pressure variation, however low, which is effectively attributable to a leak. The leak detection method according to the present disclosure thus has much higher reliability and sensitivity than those of the known methods.

By virtue of this increased sensitivity, the method according to the present disclosure advantageously allows very early detection of a minor leak, long before it exhibits an actual risk of damaging the tires or of tearing the curing membrane.

Furthermore, advantageously, managing the respective time delay and then observation durations, which remain relatively short with respect to the curing cycle time and notably with respect to the time required to extract the cured tire from the mold and to place a new green tire in the mold in order to engage a new curing cycle, allows a rapid sealing test to be performed. Thus, the implementation of the leak detection method according to the present disclosure does not, or hardly, immobilises the curing facility, and has little or no harmful consequences on the useful time of the curing facility, and therefore on the average curing cycle time, considered over several successive operations.

Moreover, it should be noted that the increased reliability provided by the method according to the present disclosure allows the occurrence of leaks that can damage the tires to be significantly reduced, and thus allows the rate of tires rendered non-compliant by such leaks to be limited over the long term, which amply compensates, in terms of industrial efficiency, for a possible slight extension of the average curing cycle time.

Finally, advantageously, as will be described hereafter, the method according to the present disclosure allows the seal of the curing membrane and the correct operation of the intake valve to be checked during the same test.

### BRIEF DESCRIPTION OF THE DRAWINGS

Further aims, features and advantages of the present disclosure will become apparent in further detail upon reading the following description and with reference to the appended drawings, which are provided purely by way of a non-limiting illustration, and in which:

FIG. 1 illustrates, as a cross-section in a plane containing the central axis of the mold, in this case a vertical plane, a curing mold in the closed configuration, during a curing operation, with the curing membrane, in this case shown as dashed lines, being placed under the curing pressure and pressing the tire against the inner wall of the mold;

FIG. 2 is a cross-section, in the same cutting plane as that of FIG. 1, of the curing mold in the open configuration, with the curing membrane being deflated, and more specifically depressurised so as to reduce its overall volume, resulting in the retraction of the membrane by folding, to allow the cured tire to be removed, immediately prior to the testing step for detecting a possible leak;

FIG. 3 is a cross-section, in the same cutting plane as that of FIGS. 1 and 2, of the curing mold in the open configuration, during a first phase of the reinflation sub-step of the testing step, with the curing membrane being in an intermediate reinflation configuration that corresponds to its rest configuration, i.e., to the configuration assumed by the membrane when the internal pressure prevailing in the inflation chamber is equal to the ambient atmospheric pressure that prevails around, and applies on, the outer surface of the membrane;

FIG. 4 is a cross-section, in the same cutting plane as that of FIGS. 1 to 3, of the curing mold in the open configuration, during a second phase of the reinflation sub-step of the testing step, with the curing membrane being partially reinflated, under an internal pressure equal to the desired test pressure, higher than the ambient atmospheric pressure and lower than the curing pressure, and with the curing membrane being isolated by closing the supply valve to allow the stabilisation and then the observation sub-steps for detecting a possible leak to continue;

FIG. 5 is an overall perspective view of a curing membrane according to the present disclosure, in the rest configuration;

FIG. 6 is a graph schematically illustrating the evolution of the internal pressure prevailing in the inflation chamber, and therefore more generally in the curing membrane, as a function of time, during a testing step according to the present disclosure, and notably revealing the various sub-steps of partial reinflation, time delay stabilisation and then observation. On this graph, the scenario shown as a solid line during the observation sub-step reflects a low pressure drop that corresponds to the absence of a leak, the scenario shown as a mixed line, which reflects a significant pressure drop during the observation period, corresponds to a leak in the curing membrane, and the scenario shown as dashed lines, which reflects an increase in pressure during the observation period, corresponds to a leak in the intake valve; and

FIG. 7 is a graph illustrating the evolution of the pressure prevailing in the curing membrane during a sequence initially comprising a testing step according to the present disclosure, then an operation for curing a tire.

### DETAILED DESCRIPTION OF THE ENABLING EMBODIMENT

The present disclosure relates to a leak detection method for detecting a leak within a curing facility 1 for curing tires 2.

The tires 2 are intended to fit vehicle wheels, and notably can form pneumatic tires, within which the wall of the tire defines, with the rim on which the tire is mounted, a chamber filled with a pressurised gas that supports the tire, or even “airless” tires that are supported by a network of spokes rather than by a chamber filled with pressurised gas. The tires 2 can also, as a variant, be caterpillar tracks.

Preferably, the tires 2 comprise one or more rubber-based components.

All or some of these rubber-based components, and therefore more generally the tire 2, are initially found in the uncured state, i.e., unvulcanised, and the curing facility 1 advantageously allows a curing operation to be implemented for vulcanising the one or more rubber-based components in order to obtain a cured tire.

By way of an indication, the curing operation generally occurs at a temperature ranging between 130° C. and 200° C.

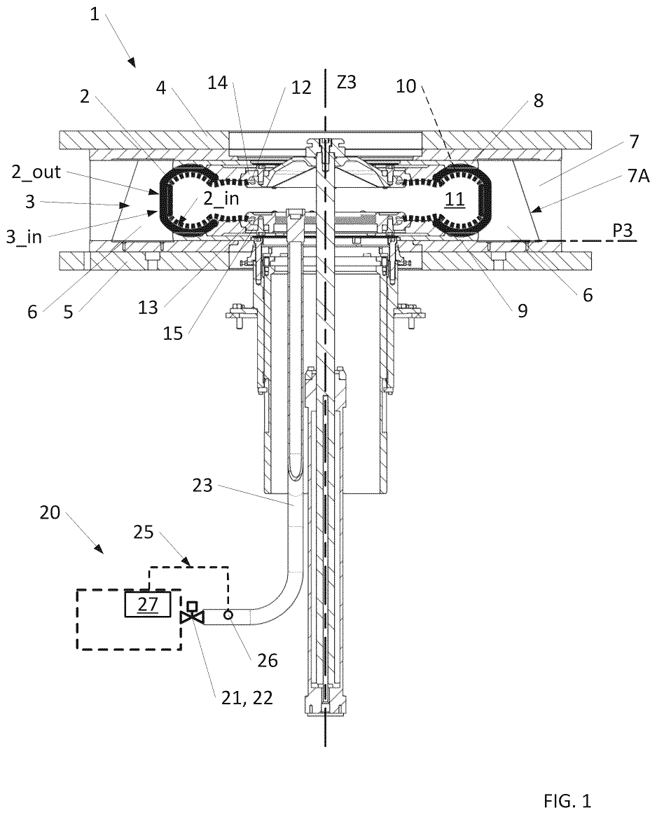

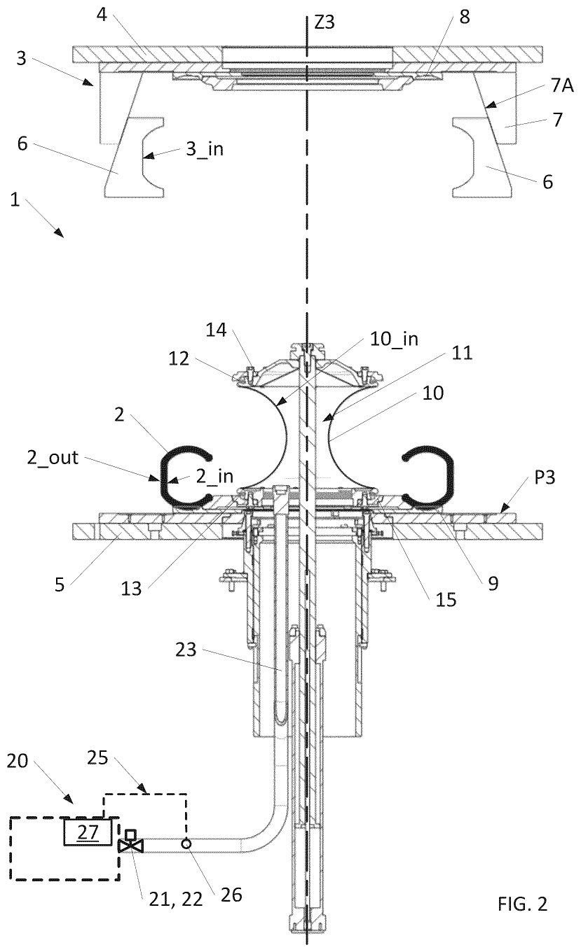

As can be seen in FIGS. 1, 2 and 3, the facility comprises a mold 3, which is arranged to alternately assume a closed configuration (FIG. 1), in which the inner wall 3_in of the mold 3, which corresponds to the negative impression of the tire 2, delimits a molding cavity and allows an operation for curing the tire 2, and an open configuration (FIGS. 2, 3 and 4), which allows a cured tire 2 to be extracted from the mold 3 after the curing operation and to be replaced with a green tire 2.

In a manner known per se, the mold 3 has a central axis Z3, in this case vertical, relative to which the mold 3 substantially assumes a rotary shape, and which corresponds to the central axis of the tire 2 to be cured.

The mold 3 also comprises plates 4, 5, in this case a lower plate 4 and an upper plate 5, which are movable relative to each other along the central axis Z3, so as to be able to alternately approach each other to ensure that the mold 3 is closed, and to move away from each other to ensure that the mold 3 is opened.

The opening and closing of the mold 3 occur along a joint plane denoted P3.

The mold 3 comprises a set of blocks 6, called “sectors” 6, which each cover a predetermined angular sector around the central axis Z3, and which together form an annular structure, the inner wall of which, which forms part of the inner wall 3_in of the mold, corresponds to the negative impression of the crown of the tire 2. In a manner known per se, the sectors 6 are fitted with sipes that protrude towards the inside of the molding cavity and the design of which corresponds to that of the tread patterns of the tread of the tire 2.

The mold 3 preferably further comprises an annular hoop 7, which is axially movable along the central axis Z3 and which cooperates along a frustoconical ramp 7A with the sectors 6, so as to be able to alternately force the centripetal radial approach of the sectors 6 when the mold 3 is closed, and then force the centrifugal radial separation of the sectors when the mold 3 is opened.

The mold 3 further comprises shells 8, 9, which are supported by the plates 4, 5 and an inner wall of which, which forms another part of the inner wall 3_in of the mold, allows the sidewalls of the tire to be shaped, and certain markings to be affixed thereto, notably regulatory markings.

The facility 1, and more specifically the mold 3, also comprises a curing membrane 10, the inner surface 10_in of which delimits an inflation chamber 11, which allows the curing membrane 10 to be inflated, and the outer surface 10_out of which is arranged, during the curing operation and under the action of a pressure, called “curing pressure” P_cur, that is applied in the inflation chamber 11, to come into abutment against the inner surface 2_in of the tire 2 in order to press the tire 2, and more specifically the outer surface 2 out of the tire 2, against the inner wall 3_in of the mold 3, as illustrated in FIG. 1.

The curing membrane 10, in a manner known per se, preferably has, notably at rest, in the absence of internal overpressure relative to the ambient pressure, a rotary shape about the central axis Z3, that is a straight cylindrical shape, with the generatrices of the membrane being parallel to the central axis Z3, or curved in the shape of a barrel, as illustrated in FIG. 5, with the generatrices of the membrane then being curved relative to the central axis Z3.

The curing membrane 10 is made of an elasticly deformable material, such as vulcanised rubber, to allow the curing membrane to expand, and therefore to allow the volume of the inflation chamber 11 to expand, under the effect of the pressure exerted in the inflation chamber 11.

The thickness of the curing membrane 10, which corresponds to the distance separating the outer surface 10_out from the inner surface 10_in, generally ranges, at rest, between 4 mm and 15 mm, and, for example, between 4 mm and 6 mm, when the facility is intended for curing tires intended for passenger vehicles, generally up to 10 mm for curing tires intended for heavy goods vehicles, and beyond for curing tires intended for civil engineering machines.

The curing membrane 10 has, at each axial end thereof, an annular bulge forming a bead 12, 13 that is sealably retained by a flange 14, 15.

The facility 1 further comprises an inflation circuit 20, which comprises at least one intake valve 21 for introducing a pressurised inflation fluid into the curing membrane 10, in the inflation chamber 11, in order to inflate the curing membrane 10.

The inflation circuit 20 also comprises at least one exhaust valve 22 for discharging the inflation fluid out of the inflation chamber 11 in order to deflate the curing membrane 10.

According to a possible alternative embodiment, and as illustrated in FIGS. 1 and 2, the intake valve 21 and the exhaust valve 22 can be merged into the same valve, which advantageously forms an isolation valve, with the connection between the inflation circuit 20 and the inflation chamber 11 being made by a single pipe 23 that supports the isolation valve and that in turn acts as the intake and then the exhaust for the inflation fluid, and therefore for the inflation and then the deflation of the curing membrane 10.

According to another alternative embodiment, the intake valve 21 and the exhaust valve 22 are separate, with the intake and the exhaust occurring via two separate pipes that each connect with the inflation chamber 11, namely, a first pipe supporting the intake valve 21 and a second pipe supporting the exhaust valve 22.

In a manner known per se, the inflation circuit 20 comprises a compressor and/or an accumulator (not shown) that allow the inflation chamber 11 to be supplied with the pressurised inflation fluid, via the intake valve 21.

“Pressurised” conventionally indicates that the inflation fluid is overpressured relative to the ambient pressure, and more specifically to the ambient atmospheric pressure P_atm that prevails in the installation area of the facility 1, and more specifically that prevails around the mold 3.

According to a preferred embodiment, the inflation circuit 20 can also comprise a suction system, such as a vacuum pump, for temporarily placing the inflation chamber 11 under negative pressure, i.e., under an internal pressure that is lower than the ambient pressure that prevails around the mold 3, and therefore in particular that is lower than the ambient pressure that prevails on the outer surface 10_out of the curing membrane 10, when the mold 3 is in the open configuration, in order to retract the curing membrane 10 on itself, as illustrated in FIG. 2, and thus prevent the curing membrane 10 from interfering with the tire 2, and notably with the beads of the tire 2, when the tire 2 is extracted from the mold 3 after curing or a new green tire 2 is introduced into the mold 3.

The facility 1 also comprises a pressure measurement device 25 arranged to measure the pressure, called “internal pressure”, that prevails inside the curing membrane 10, in the inflation chamber 11.

This pressure measurement device 25 can comprise a pressure sensor 26, of any suitable type, which pressure sensor 26 can be located, for example, on a portion of the pipe 23 that permanently connects with the inflation chamber 11, in this case a portion of the pipe 23 included between the intake valve 21 and the inflation chamber 11.

The facility 1 further advantageously comprises a control unit 27, preferably electronic, such as a programmable logic controller, which allows the internal pressure that prevails within the curing membrane 10, in the inflation chamber 11, to be regulated.

The control unit 27 is advantageously connected to the pressure measurement device 25, and allows the inflation circuit 20 to be controlled, preferably automatically, and more specifically the opening and closing of the intake valve 21 and the exhaust valve 22, depending on a selected pressure setpoint or regulation law. The intake valve 21 and the exhaust valve 22 advantageously can be solenoid valves that can be controlled by electrical control signals transmitted by the control unit 27.

Thus, the control unit 27 allows the inflation chamber 11 to be sometimes connected with the intake circuit of the inflation circuit 20, and therefore with the compressor or the accumulator, in order to increase the internal pressure by injecting pressurised inflation fluid into the inflation chamber 11, and sometimes with the exhaust circuit of the inflation circuit 20, which allows a reduction in the internal pressure by allowing the inflation fluid to escape from the inflation chamber, or even which generates forced emptying of the inflation fluid by placing the inflation chamber 11 under negative pressure (vacuum).

The control unit 27 also allows, as will be seen hereafter, the inflation chamber 11 to be isolated from the inflation circuit 20, so that the inflation chamber no longer connects with the intake circuit or with the exhaust circuit, in order to leave the internal pressure, which prevails in the inflation chamber 11, thus separated from the inflation circuit 20, to freely, passively evolve, without being subjected to active regulation. In other words, the control unit 27 can, when necessary, inhibit the pressure regulation, notably, as will be seen hereafter, in order to be able to detect an abnormal variation of the internal pressure that would be indicative of a leak.

According to the present disclosure, the method initially comprises a step (S100) of opening the mold 3, during which step, after having deflated the curing membrane 10, the mold 3 is placed in the open configuration, as illustrated in FIG. 2.

To this end, the hoop 7, in this case supported by the upper plate 4, is moved so as to radially space apart the sectors 6 so as to disengage the sectors 6 beyond the radial limits of the cured tire 2, then the upper plate 4, which draws the hoop 7 and the spaced sectors 6 therewith, is axially lifted so as to expose the lower plate 5, the tire 3, which rests on the lower plate 5, and the curing membrane 10, which is in the deflated state, in this case more specifically in a retracted state due to being placed in a vacuum.

It is thus possible to access the cured tire 2 and to remove it from the mold 3, by sliding the axially cured tire 2 along the curing membrane 10 by means of a suitable manipulator, such as a robotic arm.

It should be noted that, during this step (S100) of opening the mold 3, the curing membrane 10, and more specifically the inflation chamber 11, can be set to an internal pressure that is substantially equal to the ambient atmospheric pressure P_atm, in order to allow the curing membrane to return, by elastic return, to its resting dimensions, or even can be temporarily placed in a vacuum at an internal pressure that is strictly lower than the ambient atmospheric pressure P_atm, by connecting the exhaust circuit to a suction or vacuum device, so as to force the radial contraction of the curing membrane 10 towards the central axis Z3, as illustrated in FIG. 2, in order to minimise the radial footprint, and more generally the volume, of the curing membrane 10 in order to facilitate the extraction of the tire 2.

By simple convention, a “simple” deflation state will be considered when the internal pressure ranges between −0.02 bar (minus 0.02 bar) and +0.02 bar (plus 0.02 bar) in the inflation chamber 11, and a vacuum-assisted deflation state is considered when the internal pressure is less than or equal to −0.3 bar (minus 0.3 bar), for example, ranging between −0.5 bar (minus 0.5 bar) and −0.3 bar (minus 0.3 bar).

It should be noted that, unless otherwise indicated, the pressure values are indicated as relative pressure relative to the ambient pressure, which is considered to be zero. Thus, in particular, a relative pressure of −1 bar (minus one bar) represents the absolute vacuum.

Following the step (S100) of opening the mold 3, and more preferably after removing the cured tire 2 from the open mold 3, the method according to the present disclosure comprises a testing step (S200).

This testing step (S200) allows the seal of the curing membrane 10 to be tested, in order to detect a possible leak, and notably a slight leak related to a small perforation.

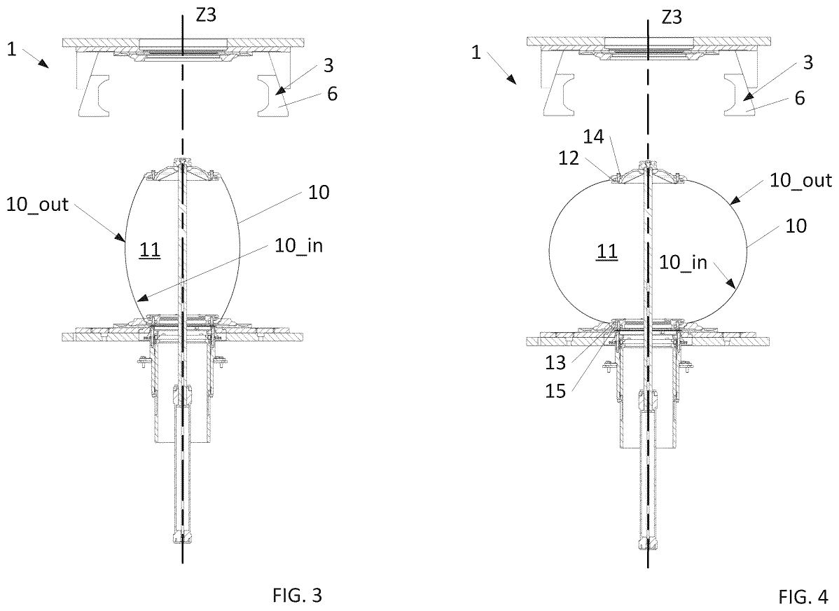

The testing step (S200) comprises a partial reinflation sub-step (S201), during which, while the mold 3 is in the open configuration, the opening of the intake valve 21 is controlled in order to introduce inflation fluid into the inflation chamber 11 so as to increase the internal pressure that prevails in the inflation chamber 11 and thus cause the curing membrane 10 to reinflate, as shown in FIGS. 3 and 4, while measuring the internal pressure prevailing in the inflation chamber 11 by means of the pressure measurement device 25.

It should be noted that, advantageously, prior to this partial reinflation sub-step (S201), the curing mold 3 was placed in the open configuration and the curing membrane 10 was positioned in the space in such a way that the reinflation of the curing membrane 10 can be performed freely, in a volume of the free space, without the outer surface 10 out of the curing membrane encountering any obstacle that could mask a leak, and more specifically without the outer surface 10_out of the curing membrane 10, under the effect of the movement of the curing membrane 10 induced by the reinflation, coming into abutment against a tire portion 2 or against a portion of the inner wall 3_in of the mold 3.

Thus, in the partial reinflation sub-step (S201), the curing membrane 10 extends freely, under the effect of the pressure difference that exists between the inner surface 10_in, subjected to the inflation fluid, and the outer surface 10_out of the curing membrane, subjected to the pressure of the ambient atmosphere, until an equilibrium state is reached that depends on this pressure difference and on the intrinsic elasticity of the curing membrane 10.

Advantageously, the fact that the curing membrane 10 inflates freely notably ensures that no perforation affecting the curing membrane 10 will be obstructed, and, on the contrary, that any perforation will be expanded by the partial reinflation operation, and therefore will be more easily detectable, so that the entire surface of the curing membrane 10 included between the two beads 12, 13 effectively undergoes the sealing test.

Of course, if the inflation circuit 20 comprises an exhaust valve 22 that is distinct from the intake valve 21, the exhaust valve 22 is preferably closed prior to the partial reinflation sub-step (S201), so that the reinflation operation occurs while the exhaust valve 22 is in the closed state, and therefore prevents the inflation fluid from escaping from the inflation chamber 11.

The partial reinflation sub-step (S201) is advantageously performed under the control of the control unit 27.

The testing step (S200) then comprises, immediately following the partial reinflation sub-step (S201), a stabilisation sub-step (S202), which is triggered when the internal pressure prevailing in the inflation chamber 11 reaches a predetermined threshold, called “test pressure” P_test, which is selected so as to be less than the curing pressure P, and according to which the inflation chamber 11 is isolated by controlling the closure of the intake valve 21.

It should be noted that the reinflation is effectively “partial”, in that the reinflation brings the internal pressure to a test pressure P_test that is lower, and even much lower, than the nominal curing pressure P_cur.

Thus, the test pressure P_test is selected so as to be low enough to prevent the reinflation from causing tearing or hazardous bursting of the curing membrane 10.

However, the test pressure value P_test is clearly selected so as to be high enough to allow possible leaks to be highlighted, notably by causing an expansion of the curing membrane 10, and more specifically an elastic extension of the curing membrane 10, which causes widening of any possible perforations. In particular, the test pressure is clearly strictly greater than the ambient pressure, in this case in practice the ambient atmospheric pressure, that prevails around the curing membrane 10 and around the mold 3, and which is exerted on the outer surface 10_out of the curing membrane 10 when the mold is in the open configuration.

For the aforementioned reasons, the test pressure P_test, which is used as a threshold for triggering the stabilisation sub-step (S202) and therefore the isolation of the inflation chamber 11, and therefore for defining the end of the partial reinflation sub-step (S201), is preferably equal to or greater than 30 mbar, preferably equal to or greater than 50 mbar, more preferably equal to or greater than 80 mbar. As indicated above, such a low limit value ensures sufficient reinflation of the curing membrane 10 in order to properly indicate a possible leak.

Furthermore, the test pressure P_test is less than or equal to 1 bar, preferably less than or equal to 350 mbar, more preferably less than or equal to 200 mbar, and even more preferably less than or equal to 130 mbar. As indicated above, such a high limit value notably avoids sudden tearing of the curing membrane 10.

Particularly preferably, the test pressure P_test can range between 30 mbar and 130 mbar, even more preferably between 80 mbar and 130 mbar, and, for example, can be equal to 120 mbar.

Advantageously, the leak detection according to the present disclosure can therefore occur at relatively low pressure, in a particularly safe manner for the operators and the hardware, and with low energy expenditure.

It should be noted that, by convention, the values of the internal pressure referred to in the present application are expressed as relative values, i.e., they correspond to the pressure difference that exists between the inside of the inflation chamber 11, and therefore more generally the inside of the curing membrane 10, on the one hand, and the outside of the curing membrane 10, on the other hand, i.e., to the pressure difference that exists between the internal pressure that is exerted on the inner surface 10_in of the curing membrane and the external pressure, the ambient atmosphere, that is exerted on the outer surface 10_out of the curing membrane, when the curing mold 3 is in the open configuration.

In practice, the test pressure values P_test indicated above, and more generally the pressure values indicated in the present application, therefore, unless otherwise specified, correspond to relative pressure values expressed relative to the ambient atmospheric pressure of the site where the facility 1 is located.

As soon as the internal pressure reaches the desired test pressure value P_test, the isolation of the inflation chamber 11 is triggered, so as to separate the inflation chamber 11 from the inflation circuit 20, which amounts to confining the inflation fluid present in the inflation chamber 11 inside the inflation chamber 11, and to inhibiting the regulation of the internal pressure, and thus allowing the internal pressure to evolve freely within the captive volume of the curing membrane 10, and more specifically of the inflation chamber 11.

It should be noted that, strictly speaking, the captive volume affected by the isolation comprises not only the volume of the inflation chamber 11 strictly speaking, but also the portion of the inflation circuit 20 that remains connected with the inflation chamber 11, so that the captive volume extends from the downstream outlet of the intake valve 21 to the upstream inlet of the exhaust valve 22 by passing through, and including, the volume of the inflation chamber 11. However, for the simple convenience of the description, reference can be made to the volume of the inflation chamber 11 in order to designate this captive volume.

According to the time delay sub-step (S202), a time delay with a predetermined duration d_202, called “time delay period” d_202 is applied, and, at the end of the time delay period d_202, the value, called “reference pressure” value P_ref, of the internal pressure that prevails in the inflation chamber 11 is measured.

Triggering the control of the intake valve 21 and triggering the time delay are advantageously simultaneous, and caused by the fact that the internal pressure exceeds the threshold that the test pressure P_test represents. In practice, the control unit 27 therefore simultaneously sends a closing command to the intake valve 21 and a start command to a timer programmed for the time delay period d_202, from the instant t1 at which the control unit 27 picked up and processed the information originating from the pressure measurement device 25, according to which the internal pressure has reached the test pressure P_test.

As indicated above, this time delay period d_202 will correspond to a stabilisation period, during which the system, which in principle is closed, stabilises and which constitutes the inflation fluid that is contained in the inflation chamber 11 and that is delivered thereto, in the absence of active regulation, following the closure of the intake valve 21.

In particular, the time delay will allow the measurement of the reference pressure P_ref to be deferred following the passage and the attenuation, or even the extinction, of transient disruptions resulting from the operation for closing the intake valve 21.

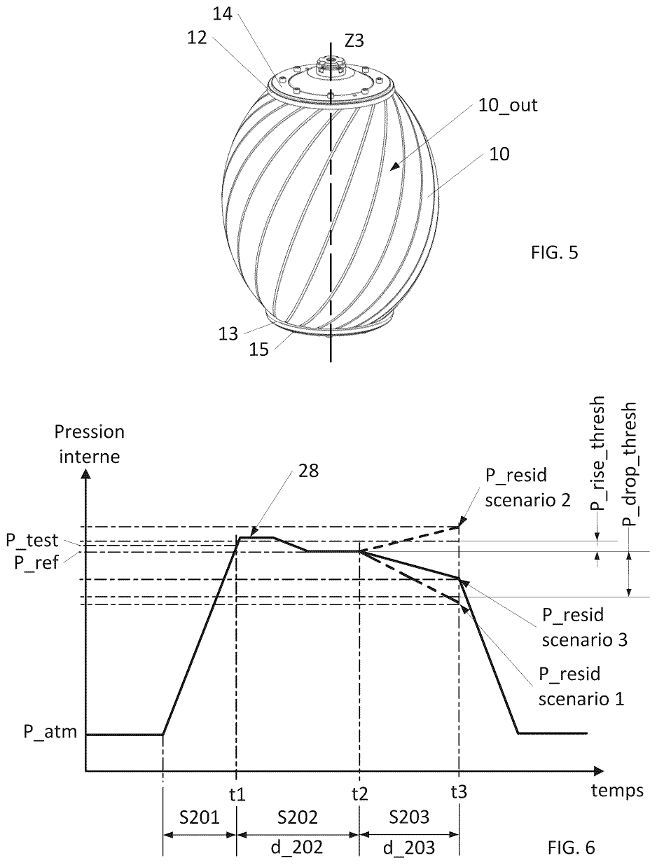

For example, as shown in the graph of FIG. 6, the time delay will allow the measurement of the reference pressure P_ref to be deferred after the passage of a possible overshoot 28, i.e., a temporary overpressure relative to the threshold, that represents the test pressure P_test, which overshoot 28 results from the inertia due to the response time for closing the intake valve 21, as well as the response time of the pressure sensor 26 and the corresponding acquisition chain of the pressure measurement device 25, because these response times allow the very fast pressure rise phase initiated by the partial reinflation sub-step (S201) to be extended.

Thus, the value of the reference pressure P_ref that effectively will be measured and used as a reference for detecting possible leaks will correspond to a stabilised value, not polluted by transient disruptions such as an overshoot or spurious oscillations.

It should be noted that, in practice, the reference pressure P_ref, as can be seen at the end of the time delay, and more generally at the end of the stabilisation sub-step (S202), can, depending on the case, and notably as a function of the volume of the membrane and of the temperature, be either lower or higher, or substantially equal to the setpoint represented by the test pressure P_test. The representation of FIG. 6, on which the reference pressure P_ref appears lower than the test pressure P_test, is therefore not restrictive.

Preferably, the time delay period d_202 is selected so as to be equal to or greater than 2 seconds, preferably equal to or greater than 3 seconds, and more preferably equal to or greater than 4 seconds.

Thus, the low limit value of the duration of the time delay period d_202 is long enough to ensure that any transient disruptions have been avoided that are related to activating the closure of the intake valve 21, to the reaction time of the intake valve 21 and of the pressure measurement device 25, and, if applicable, to the visco-elastic behaviour of the curing membrane 10, such as, for example, overshooting 28 the internal pressure beyond the test pressure value P_test or damped oscillations of the internal pressure.

Furthermore, and notably in consideration of either of the aforementioned low time delay period values d_202, the time delay period d_202 is preferably also less than or equal to 60 seconds, preferably less than or equal to 30 seconds, more preferably less than or equal to 20 seconds, or even less than or equal to 10 seconds.

Thus, the upper limit value of the time delay period is short enough so as not to unnecessarily extend the stabilisation sub-step (S202), and, consequently, so as not to unnecessarily delay the observation sub-step (S203) and therefore the effective leak searching operation strictly speaking.

In practice, in most cases, the time delay period d_202 will range between 4 seconds and 30 seconds.

By way of an example, the time delay period d_202 can be equal to 5 seconds.

Following the stabilisation sub-step (S202), the testing step (S200) comprises an observation sub-step (S203), which involves observing how the internal pressure prevailing in the inflation chamber 11 evolves over a predetermined duration, called “observation period” d_203, in order to identify an evolution of the internal pressure, relative to the reference pressure P_ref, which represents a leakage situation.

The observation sub-step (S203) advantageously immediately follows the stabilisation sub-step (S202), and therefore starts at the instant t2 when the measurement of the reference pressure P_ref is acquired, and marks the end of the time delay period d_202 and of the stabilisation sub-step (S202).

Preferably, the imparted observation period d_203 is equal to or greater than 5 seconds, preferably equal to or greater than 10 seconds, more preferably equal to or greater than 20 seconds.

Thus, the low limit value of the duration of the observation period d_203 is long enough to be able to obtain a variation in the internal pressure, notably a drop in the internal pressure, which is large enough to be detectable, even in the event that the leakage rate is low, due, for example, to the small size of the perforation affecting the curing membrane.

Furthermore, and notably in consideration of either of the aforementioned low limit values of the observation period d_203, the duration of the observation period d_203 is preferably less than or equal to 5 minutes, preferably less than or equal to 3 minutes, more preferably less than or equal to 60 seconds, or even less than or equal to 45 seconds.

Thus, the upper limit value of the duration of the observation period d_203 is short enough so as to not unnecessarily extend the duration of the testing step (S200).

In practice, in most cases, the observation period d_203 will range between 5 seconds and 30 seconds.

Furthermore, the observation period d_203 preferably will be longer than the time delay period d_202. Indeed, the transient disruptive phenomena intended to be covered by the time delay period d_202 are generally fairly fleeting, while there may be a requirement, during the observation sub-step (S203), for a relatively longer observation time in order to obtain a pressure variation, attributable to a small leak, that is large enough to be significant and detectable.

By way of an example, the observation period d_203 can be equal to 30 seconds, notably following a time delay period d_202 that will have been equal to 5 seconds.

The observation of the evolution of the internal pressure during the observation period d_203 can be performed, for example:
either by continuously measuring, and, if applicable, by recording, the internal pressure over time, from the instant t2 that marks the start of the observation period d_203, and by progressively comparing this instantaneous internal pressure with the reference pressure P_ref, for example, in order to detect whether a pressure threshold or a pressure variation speed threshold has been exceeded;
or by taking a one-off measurement of the internal pressure, for example, at the instant t3 that marks the end of the observation period d_203, and by comparing this one-off measurement with the value of the reference pressure P_ref that prevailed at the start of the observation period, at the instant t2.

Whether it is a continuous or a one-off measurement, measuring the value of the internal pressure is advantageously performed by means of the aforementioned pressure measurement device 25, and more specifically by means of the pressure sensor 26.

As indicated above, the observation sub-step (S203) involves observing how the internal pressure prevailing in the inflation chamber 11 evolves over the observation period d_203 in order to identify an evolution of the internal pressure, relative to the reference pressure P_ref, which represents a leakage situation.

This analysis operation in practice can be performed jointly, simultaneously or practically simultaneously, with the acquisition of the internal pressure measurement performed during the observation period d_203.

The acquisition and processing of the internal pressure measurements are advantageously performed by the control unit 27, which has a computer programmed to this end.

The analysis operation notably allows the identification, from among several scenarios of the evolution of the internal pressure that will have been predetermined, of a scenario that is indicative of a leak, and thus allows the presence of a leak to be detected.

More preferably, the analysis operation can allow the source of the leak to be identified, and notably can be used to determine whether the leak affects the curing membrane 10 or even the intake valve 21, i.e., to characterize the leak, as a function of the evolution scenario of the internal pressure that has been observed.

The analysis operation, and therefore the identification of the scenario, could rely on various parameters, such as, for example, the internal pressure variation speed per unit of time, or whether the internal pressure has exceeded (above or below) a preset pressure threshold during the observation period d_203, etc.

Preferably, the magnitude and the sign of the observed internal pressure variation are computed and monitored to this end, during the observation period d_203, and more specifically at the end of the observation period d_203, relative to the reference pressure P_ref.

According to a preferred implementation possibility, which is also applicable irrespective of the one or more leakage scenarios that are the subject of the observation sub-step (S203) and of the analysis operation, during the observation sub-step (S203) the internal pressure, called “residual pressure” P_resid, that prevails in the inflation chamber 11 at the end of the observation period d_203 is measured, in this case therefore at the instant t3, and the difference Delta_P, called “deviation” Delta P, between the residual pressure P_resid and the reference pressure P_ref is computed in order to determine the sign and the amplitude of the observed evolution:

$$Delta\_P = P\_resid - P\_ref$$

Thus, in a particularly simple manner, the algebraic difference is computed between, on the one hand, the residual pressure P_resid, i.e., the internal pressure measured at the instant t3 where the observation period d_203 ends, and, on the other hand, the reference pressure P ref, i.e., the previously measured internal pressure, at the instant t2 where the time delay period d_202 has ended and where the observation period d_203 has started.

This difference advantageously provides two items of information: the sign of the pressure evolution, negative for a reduction, positive for a rise, and the amplitude of the observed deviation relative to the reference pressure P_ref. This deviation, adjusted for the elapsed time, in this case equal to t3−t2, between the measurement of the residual pressure P res and the measurement of the reference pressure P_ref, advantageously allows the absence or the presence of a leakage rate, and, if applicable, the source and/or the magnitude of the leakage rate to be characterised.

It should be noted that, as a variant, the internal pressure could be continuously monitored during the observation period d_203, the difference between the instantaneous internal pressure and the reference pressure P_ref could be computed in real time, and the presence of a leak could be determined as soon as this difference exceeds, as an absolute value, a predefined alert threshold, even before the observation period d_203 has ended.

However, with the total duration selected for the observation period d_203 being relatively short, the time gain provided by such a variant would not be significant, especially with regard to the duration that is required to replace the curing membrane 10 when a leak is detected.

It will therefore be preferable, by saving measurement and computation operations, to opt for a simple one-off reading of the residual pressure P_resid at the instant t3 that marks the end of the observation period d_203, rather than for continuous monitoring.

According to a preferred implementation possibility, during the observation sub-step (S203), a reduction in the internal pressure is observed over the observation period d_203, with the amplitude of the reduction being, as an absolute value relative to the reference pressure P_ref, greater than a predetermined threshold, called “drop threshold” P_drop, and a leakage situation of the curing membrane 10 is inferred.

In other words, a first evolution scenario is identified in this case that is indicative of a leakage situation where the leak affects the curing membrane 10.

This first scenario, denoted “scenario 1” and depicted as a mixed line in FIG. 6, in this case is characterized by a deviation Delta_P, i.e., an algebraic difference Delta_P=P_resid−P_ref mentioned above, the sign of which is negative and the amplitude of which is, as an absolute value, greater than the drop threshold P_drop_thresh.

If this first scenario is detected, a membrane failure alert is triggered, in this case by means of the control unit 27, in order to cause the production of the tires by the curing facility 1 to be stopped, and the defective curing membrane 10 to be replaced.

Preferably, the drop threshold P_drop_thresh ranges, as an absolute value, between 10 mbar and 150 mbar, preferably equal to 10 mbar.

Alternatively, or even equivalently, the drop threshold P_drop_thresh can be defined as a fraction of the reference pressure P_ref, which can prove useful, for example, if it is difficult to reproducibly manage the reference pressure P_ref from one test to the next, because the reference pressure P_ref tends to fluctuate from one test to the next although the value of the selected test pressure P_test is identical for these different tests. Thus, for example, it is possible to select the drop threshold P_drop_thresh in a range of values ranging between 5 % and 20 % of the reference pressure P_ref, for example, between 8 % and 10 % of the reference pressure P_ref; specifically, this can amount to setting a drop threshold P_drop_thresh of the order of 10 mbar to 12 mbar with respect to a measured reference pressure P_ref of the order of 120 mbar.

According to another preferred implementation possibility, which can supplement the previous one, during the observation sub-step (S203), an increase in the internal pressure is observed, with the increase having an amplitude, as an absolute value relative to the reference pressure P_ref, that is greater than a predetermined threshold, called “rise threshold” P_rise_thresh, and, during the analysis sub-step (S204), a leakage situation of the intake valve 21 is inferred.

In other words, a second evolution scenario is identified in this case that is indicative of a leakage situation where the leak this time affects the intake valve 21. Indeed, such a second scenario is indicative of a failure of the intake valve 21, which, poorly closed, lets the pressurised inflation fluid continue to penetrate inside the curing membrane 10, into the inflation chamber 11.

This second scenario, denoted “scenario 2” and depicted as a dashed line in FIG. 6, in this case is characterized by a deviation Delta_P, i.e., an algebraic difference Delta_P=P resid−P_ref mentioned above, the sign of which is positive and the amplitude of which is, as an absolute value, greater than the rise threshold P rise thresh.

If this second scenario is detected, a valve failure alert is triggered, in this case by means of the control unit 27, in order to stop the production of tires and to instigate an inspection of the facility 1 and a maintenance operation for the intake valve 21.

Particularly preferably, the rise threshold P_rise thresh can be selected so as to be equal to 0 (zero) mbar, insofar as it can be considered that the slightest increase in the internal pressure that would occur, after the stabilisation offered by the time delay period d_202, relative to the reference pressure P_ref, can only result from a failure of the intake valve 21.

Thus, according to a preferred implementation possibility, over the observation period d_203, an increase in the internal pressure relative to the reference pressure P_ref can be observed, and a leakage situation of the intake valve 21 will then be inferred.

Generally, the method, in this case the testing step (S200), therefore provides, and is used to identify, at least one scenario of the evolution of the internal pressure that is indicative of a leakage situation, and even more preferably anticipates (at least) two scenarios of the evolution of the internal pressure that are each indicative of a leakage situation, from among:
a first scenario that is indicative of a leak affecting the curing membrane 10;
a second scenario that is indicative of a leak affecting the intake valve 21.

As indicated above, the identification of either scenario, and therefore the diagnosis of the presence or the absence of a leak, is preferably performed by computing the deviation Delta_P between the residual pressure P_resid measured at the end of the observation period d_203 and the reference pressure P_ref measured at the end of the time delay period d_202, and by examining, on the one hand, the positive or negative sign of this deviation Delta_P, and, on the other hand, the amplitude of this deviation Delta_P, which amplitude can be compared to this end with the aforementioned drop P_drop_thresh and rise P_rise_thresh thresholds.

Advantageously, the same testing step (S200) can thus allow both the seal of the curing membrane 10 and the seal, and more generally the correct operation, of the intake valve 21 to be checked, which intake valve 21 forms, if applicable, the single isolation valve for selectively connecting the inflation chamber 11 with the inflation circuit 20 or, on the contrary, for isolating the inflation chamber 11 from the inflation circuit 20.

Of course, if, according to a scenario, called “normal evolution scenario”, or, if applicable, “third scenario”, denoted “scenario 3” and depicted as a solid line in FIG. 6, the following is observed during the analysis operation:
the deviation Delta P remains contained between the drop P_drop_thresh, on the one hand, and rise P_rise_thresh thresholds, on the other hand, i.e., the deviation Delta_P remains contained in the range [−P_drop_thresh; +P_rise_thresh];
or, equivalently, the measured residual pressure P_resid ranges between P_ref−P_drop_thresh (low limit) and P_ref+P_rise_thresh (high limit);
   then the absence of a leak is inferred, as is the possibility of engaging a new curing cycle with the same curing membrane 10, notably without having to proceed with the replacement of the curing membrane 10.

These various scenarios are illustrated in FIG. 6.

After the observation sub-step (S203), the curing membrane 10 is deflated, so that the internal pressure that prevails in the inflation chamber 11 is lowered to a level that is equal to, or is even less than, the ambient atmospheric pressure P_atm.

To this end, the control unit 27 preferably connects the inflation chamber 11, via the exhaust valve 22, firstly with an exhaust line that opens into the open air, at the ambient atmospheric pressure P_atm, and then, in order to accelerate the end of the emptying process and to assist the retraction of the curing membrane 10, with a vacuum circuit creating a negative pressure, as described above.

Thus, the curing membrane 10 returns to a retracted state, in which the curing membrane 10 is folded on itself, and which will allow a new green tire 2 to be placed in the mold 3 and will then allow the mold 3 to be closed for a new curing operation.

Preferably, the inflation fluid used for the testing step (S200) is a dry gas, i.e., a gas that has, when it reaches the intake valve 21, and therefore, more generally, when it enters and occupies the inflation chamber 11, specific humidity that is less than or equal to 0.005 kg/kg (five per thousand).

The term “specific humidity” or “water content” denotes the ratio between the body of water, in kilograms, that is contained in the considered gas and the total mass, in kilograms, of the gas (considered in the “humid” state, i.e., by including the body of water).

Advantageously, the use of a dry gas notably avoids the condensation phenomena that are liable to disrupt the evolution of the internal pressure that prevails in the curing membrane 10, and therefore avoids any interpretation errors during the testing step (S200), more specifically during the observation sub-step (S203) and the analysis operation.

Furthermore, the use of a dry gas as an inflation fluid avoids having to equip the facility 1 with a water vapour generation and management circuit. Space and energy are thus saved.

Preferably, it is the same dry gas, and therefore the same inflation circuit 20, that is used, on the one hand, for the testing step (S200), and, more specifically, for the reinflation sub-step (S201), and, on the other hand, for the curing operation.

Preferably, the inflation fluid used for the testing step (S200), and more preferably also for the curing operations, is a gas containing more than 99.8 % pure dinitrogen.

Such a gas is advantageously commonly available in industry, and notably can be stored in the form of liquid dinitrogen. Furthermore, the provision of a gas is thus ensured that, on the one hand, is completely dry, for which, in this case, the volume fraction of water is, for example, less than 40 ppmv (typically 5 bar), and, on the other hand, neutral and non-hazardous.

Furthermore, it should be noted that, when the curing facility 1 is provided with a transshipment system that alternately allows, from the same side of the mold 3, the cured tire 2 to be unloaded from the mold 3 and then a green tire 2 to be subsequently loaded into the mold 3, as a replacement for the cured tire, then the testing step (S200) advantageously can be accomplished concurrently, over the duration that separates the extraction of the cured tire 2 from the mold 3, which is in the open configuration, and the re-introduction of a new green tire 2 into the mold 3. Indeed, the total duration of the testing step (S200), including the time required for reinflation, the time delay for stabilisation, then the observation and analysis, is relatively short, typically ranging between 40 seconds and 80 seconds.

In order to avoid excessively penalising the useful time of the curing facility 1, the sealing testing step (S200) according to the present disclosure is preferably not systematically performed for each curing operation, but rather is spaced apart, according to a predetermined frequency.

Thus, preferably, the testing step (S200) is applied at a predetermined frequency, called “testing frequency”, which involves spacing apart two consecutive testing steps (S200), performed on the same curing membrane 10, of a plurality of curing operations, performed with the same curing membrane 10, so that the impact of the duration of the testing step (S200) on the useful time of the facility 1 is reduced by averaging this duration of the testing step (S200) over the number of curing operations of the plurality of curing operations.

By way of an example, the sealing tests performed in accordance with the testing step (S200) will be spaced apart over an interval of at least five curing operations, at least ten curing operations, or even fifty curing operations.

In other words, the testing frequency preferably will be selected such that a testing step (S200) is performed every five, or at least five, curing steps, preferably every ten, or at least ten, curing operations, or even every fifty, or at least fifty, curing operations.

More specifically, it is therefore possible to have, for example, a testing frequency that is equal to one test every fifty curing operations, or to one test every ten curing operations, or is equal to one test every five curing operations.

Preferably, the testing frequency increases with the number of curing operations performed by the same considered curing membrane 10, according to a predetermined scheduling rule, so that the curing membrane 10 is subjected to a testing step (S200) ever more frequently as the number of curing operations to be performed by the curing membrane 10 increases.

In other words, the older the curing membrane 10 becomes, the more frequently its seal is tested. Thus, for example, the testing frequency can be set to one test for every fifty curing operations for a new curing membrane, and then adjusted to one test for every ten curing operations, and then to one test for every five curing operations.

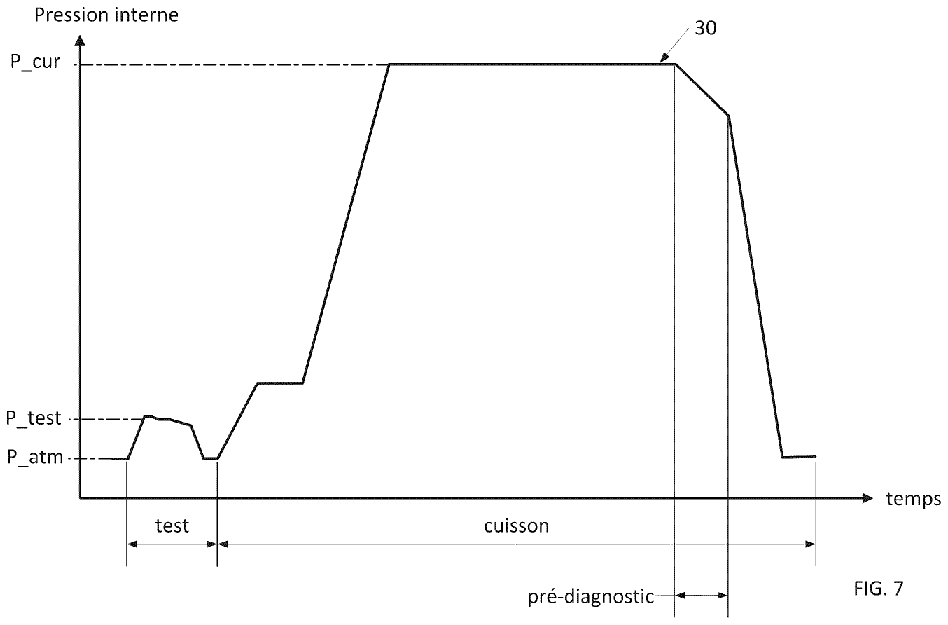

Furthermore, preferably, as can be seen in FIG. 7, and concurrently during a curing operation, and preferably during each curing operation, while the mold 3 is in the closed configuration and while the curing membrane 10 is subjected to the curing pressure P_cur, for example, in the two to four minutes preceding the end of the curing operation, a pre-diagnosis operation is performed whereby the inflation chamber 11 is isolated by controlling the closure of the intake valve 21 and the internal pressure prevailing in the curing membrane is monitored in order to be able to detect an abnormal reduction in the internal pressure indicative of a potential leak, and, in the event of the detection of such an abnormal reduction in the internal pressure indicative of a potential leak during the ongoing curing operation, the start of the curing operation following the completion of a testing step (S200) is prepared.

In particular, it is thus possible, if necessary, to force a testing step (S200) to be triggered immediately after the step (S100) of opening the mold that marks the end of the curing operation during which the pre-diagnosis operation detected a potential leak, irrespective of the initially scheduled testing frequency.

Thus, if, during the curing operation, and therefore advantageously concurrently, an advance indication of a leak is detected, then a thorough sealing test is triggered in advance, in accordance with the testing step (S200), as soon as the mold 3 is reopened, in order to definitely check the seal of the curing membrane 10 before resuming a new curing operation. Of course, if the testing step (S200) confirms the presence of a leak, then the facility 1 will be stopped until it is repaired, and notably, if necessary, until the used curing membrane 10 is replaced. Priority is thus given to production safety and quality.

Such an arrangement notably ensures, without degrading the useful time of the facility 1, an acceptable level of risk, despite spacing apart the testing steps (S200) in accordance with the testing frequency, and thus reaches an optimised compromise between the production quality and the production rate.

The pre-diagnosis operation advantageously can be triggered while a curing stage 30 is completed, during which the internal pressure has been maintained at a desired curing pressure P, as shown in FIG. 7.

By way of an indicative example, over a curing operation duration of eight minutes, it will be possible, in accordance with the pre-diagnosis operation, to isolate the inflation chamber 11, i.e., to inhibit the regulation of pressure, three minutes before the end of the curing operation, while an internal pressure of the order of 16 bar to 21 bar prevails, and for the evolution of the internal pressure to be observed. If a reduction in the internal pressure of more than 80 mbar is observed, then the suspicion of a leak is inferred, and the testing step (S200) will be forced to trigger before starting a new curing operation, for example, directly at the end of the ongoing curing operation, upon re-opening the mold 3.

It should be noted that performing the pre-diagnosis operation towards the end of the curing operation advantageously ensures that the temperature of the mold 3 is stabilised, and notably that the temperatures of the mold 3, of the tire 2 and of the curing membrane 10 are stable, and that, consequently, a possible internal pressure variation, and more specifically a possible internal pressure drop, will be properly attributable to a leak, and not to fluctuations in the temperature of the inflation fluid that is contained in the curing membrane 10, for example, to fluctuations that would be due to heat transfer from the inflation fluid to the tire 2.

Of course, the present disclosure also relates as such to a curing facility 1 for curing tires 2, the facility 1 comprising:
a mold 3, which is arranged to alternately assume a closed configuration, in which the inner wall 3 in of the mold delimits a molding cavity corresponding to the negative impression of the tire 2 and allows an operation for curing the tire, and an open configuration, which allows a cured tire 2 to be extracted from the mold after the curing operation and to be replaced with a green tire 2;
a curing membrane 10, the inner surface 10_in of which delimits an inflation chamber 11 for inflating the curing membrane 10, and the outer surface 10_out of which is arranged, during the curing operation and under the action of a pressure, called “curing pressure” P_cur, that is applied in the inflation chamber 11, to come into abutment against the inner surface 2_in of the tire in order to press the tire 2 against the inner wall 3_in of the mold 3;
an inflation circuit 20, which comprises at least one intake valve 21 for introducing a pressurised inflation fluid into the curing membrane 10, in the inflation chamber 11, in order to inflate the curing membrane 10;
a pressure measurement device 25 arranged to measure the pressure, called “internal pressure”, that prevails inside the curing membrane 10, in the inflation chamber 11;
   the facility 1 comprising a control unit 27 that is arranged to cause the facility to execute:
a step (S100) of opening the mold 3, during which step, after having deflated the curing membrane 10, the mold 3 is placed in the open configuration;
a step (S200) of testing in accordance with the leak detection method according to any one of the possibilities described above.

Of course, the present disclosure is by no means limited simply to the embodiment variants described above, and a person skilled in the art could notably isolate or freely combine any of the aforementioned features, or replace them with equivalent features.

What is claimed is:

1. A leak detection method for detecting a leak within a curing facility for curing tires, said facility comprising:
a mold, which is arranged to alternately assume a closed configuration, in which the inner wall of said mold, which corresponds to the negative impression of the tire, delimits a molding cavity and allows an operation for curing said tire, and an open configuration, which allows a cured tire to be extracted from said mold after the curing operation and to be replaced with a green tire;
a curing membrane, the inner surface of which delimits an inflation chamber for inflating the curing membrane, and the outer surface of which is arranged, during the curing operation and under the action of a curing pressure that is applied in the inflation chamber, to come into abutment against the inner surface of the tire in order to press the tire against the inner wall of the mold;
an inflation circuit, which comprises at least one intake valve for introducing a pressurised inflation fluid into the curing membrane, in the inflation chamber, in order to inflate the curing membrane;
a pressure measurement device arranged to measure an internal pressure that prevails inside the curing membrane, in the inflation chamber;
said method comprising:
a step (S100) of opening the mold, during which step, after having deflated the curing membrane, the mold is placed in the open configuration;
a testing step (S200), which comprises:
a partial reinflation sub-step (S201), during which, while the mold is in the open configuration, the opening of the intake valve is controlled in order to introduce inflation fluid into the inflation chamber so as to increase the internal pressure that prevails in said inflation chamber and thus cause the curing membrane to reinflate, while measuring said internal pressure prevailing in said inflation chamber by means of the pressure measurement device;
then a stabilisation sub-step (S202), which is triggered when the internal pressure prevailing in the inflation chamber reaches a predetermined threshold, called “test pressure” (P_test), which is selected so as to be lower than the curing pressure (P_cur), and according to which, on the one hand, the inflation chamber is isolated by controlling the closure of the intake valve, and, on the other hand, a time delay period with a predetermined duration is applied, and, at the end of said time delay period, a reference pressure of the internal pressure that prevails in the inflation chamber is measured;
then an observation sub-step (S203), which involves observing how the internal pressure prevailing in the inflation chamber evolves over an observation period, in order to identify an evolution of the internal pressure, relative to the reference pressure which represents a leakage situation.

2. The method according to claim 1, wherein the time delay period is selected, so as to be equal to or greater than 2 seconds, for the low limit value and so as to be less than or equal to 60 seconds.

3. The method according to claim 1, wherein, over the observation period, a reduction in the internal pressure is observed, with said reduction being of an amplitude, as an absolute value relative to the reference pressure, that is greater than a predetermined drop threshold and a leakage situation of the curing membrane is inferred.

4. The method according to claim 3, wherein the drop threshold ranges, as an absolute value, between 10 mbar and 150 mbar.

5. The method according to claim 1, wherein, over the observation period, an increase in the internal pressure is observed relative to the reference pressure, and a leakage situation of the intake valve is inferred.

6. The method according to claim 1, wherein the imparted observation period equal to or greater than 5 seconds for the low limit value and less than or equal to 5 minutes.

7. The method according to claim 1, wherein during the observation sub-step (S203), a residual pressure that prevails in the inflation chamber at the end of the observation period is measured, and the difference between said residual pressure and the reference pressure is computed in order to determine the sign and the amplitude of the observed evolution.

8. The method according to claim 1, wherein the inflation fluid used for the testing step (S200) is a dry gas such that, when it reaches the intake valve, it has a specific humidity that is less than or equal to 0.005 kg/kg.

9. The method according to claim 1, wherein the test pressure that is used as a threshold for triggering the stabilisation sub-step (S202) is equal to or greater than 30 mbar for the low limit value and, less than or equal to 1 bar for the high limit value.

10. The method according to claim 1, wherein the test pressure ranges between 80 mbar and 130 mbar.

11. The method according to claim 1, wherein the testing step (S200) is applied at a predetermined testing frequency which involves spacing apart two consecutive testing steps (S200), performed on the same curing membrane, of a plurality of curing operations, performed with said same curing membrane, so that the impact of the duration of the testing step (S200) on the useful time of the facility is reduced by averaging this duration of the testing step (S200) over the number of curing operations of said plurality of curing operations, with said testing frequency preferably being selected so that a testing step (S200) is performed every at least five curing operations.

12. The method according to claim 11, wherein the testing frequency increases with the number of curing operations performed by the same considered curing membrane according to a predetermined scheduling rule, so that said curing membrane is subjected to a testing step (S200) even more frequently as the number of curing operations that said curing membrane has performed increases.

13. The method according to claim 1, wherein, concurrently during a curing operation, while the mold is in the closed configuration and while the curing membrane is subjected to the curing pressure, a pre-diagnosis operation is performed whereby the inflation chamber is isolated by controlling the closure of the intake valve and the internal pressure prevailing in the curing membrane is monitored in order to be able to detect an abnormal reduction in the internal pressure indicative of a potential leak, and, in the event of the detection of such an abnormal reduction in the internal pressure indicative of a potential leak during the ongoing curing operation, the start of the curing operation following the completion of a testing step (S200) is prepared.

14. A curing facility (1) for curing tires, said facility comprising:
mold, which is arranged to alternately assume a closed configuration, in which the inner wall of said mold delimits a moulding cavity corresponding to the negative impression of the tire and allows an operation for curing said tire, and an open configuration, which allows a cured tire to be extracted from said mold after the curing operation and to be replaced with a green tire;
a curing membrane, the inner surface of which delimits an inflation chamber for inflating the curing membrane, and the outer surface of which is arranged, during the curing operation and under the action of a curing pressure, that is applied in the inflation chamber, to come into abutment against the inner surface of the tire in order to press the tire against the inner wall of the mold;
an inflation circuit, which comprises at least one intake valve for introducing a pressurised inflation fluid into the curing membrane, in the inflation chamber, in order to inflate the curing membrane;
a pressure measurement device arranged to measure an internal pressure, that prevails inside the curing membrane, in the inflation chamber;
a control unit arranged to cause said facility to execute:
a step (S100) of opening the mold, during which step, after having deflated the curing membrane, the mold is placed in the open configuration;
a step (S200) of testing in accordance with the leak detection method according to claim 1.

15. The method according to claim 2, wherein the time delay period is in the range of 4 seconds to 10 seconds.

16. The method according to claim 4, wherein the drop threshold is approximately 10 mbar.

17. The method according to claim 6, wherein the imparted observation period is in the range of 20 seconds to 45 seconds.

18. The method according to claim 7, wherein the inflation fluid contains more than 99.8% dinitrogen.

19. The method according to claim 13, wherein the curing membrane is subjected to the curing pressure for 2 to 4 minutes before the preceding the end of the curing operation.
